(19) United States
(12) Patent Application Publication
(10) Pub. No.: US 2020/0382377 A1
(43) Pub. Date: Dec. 3, 2020

(54) Polyhedral structures and network topologies for high performance computing

(71) Applicant: Jessica Cohen, Niagara Falls, NY (US)

(72) Inventor: Jessica Cohen, Niagara Falls, NY (US)

(73) Assignee: Lake of Bays Semiconductor Inc., Niagara Falls, NY (US)

(21) Appl. No.: 16/429,032

(22) Filed: Jun. 2, 2019

(51) Int. Cl. H04L 12/24; H04L 12/733; H04L 12/753; G06N 3/04

(52) U.S. Cl. CPC H04L 41/12; H04L 41/0893; G06N 3/0418; H04L 45/48; G06N 3/0454; H04L 45/122

(57) ABSTRACT

The present invention generally relates to high performance computers and datacenter environments. A self-supporting communication network includes multiple nodes, which are arranged in a polyhedral cluster, which can also be described by a networking topology. The nodes are configured to convey data traffic between source hosts and respective destination hosts by routing packets among the nodes in the shortest possible time, and with a substantially greater number of nearest network connections, for the given level of network load and contention. A routing algorithm describes this traffic. Polyhedral clusters may be close-packed into a lattice, creating a scalable exascale computer, which self-supporting, thus requiring no external racks or exoskeleton. Various configurations of close-packed lattices of polyhedral clusters may enhance different compute workloads. The cluster may also disassemble and reassemble, without requiring an extensive data center environment. The close-packing of polyhedral compute clusters enables new connections among peripheral nodes, creating dual and quad connections, scaling the connectivity and processing of its same processors. Memory is also shared among clusters, creating an enhanced distributed memory machine, or, a massively parallel shared memory system. Additionally, power, cooling, and data infrastructure are also distributed across the polyhedral topology, improving their performance, and reducing maintenance requirements. In embodiments of the present invention, conventional switches can be connected into a polyhedral topology whereby improving their performance over rectilinear configurations. The present invention offers improved performance for big data analysis, nearest neighbor computing, and deep learning workloads. The present embodiments offer improved connectivity over many topologies such as Fat Tree, Dragonfly, and others which employ radix switches with a fixed number of ports, by enabling modular network components connect in a scalable, self-supporting lattice, creating a virtually limitless network.

### FIELD OF THE INVENTION

The present invention relates generally to communication networks, and particularly to high-performance data-center, cluster and supercomputer design. The present invention also generally relates to data center environments. The present invention relates more particularly to three-dimensional topology in a communication network and in a data center.

### SUMMARY OF THE INVENTION

An embodiment of the present invention that is described herein provides a computer network configured as a cuboctahedron, whereby the properties of this solid shape afford better heat dispersion, more nearest-neighbor connections, a lattice of regularly repeating close-packing, which grows the network, and a modularity of parts whereby enabling ease of assembly in environments other than a controlled data center. Another embodiment of the present invention provides a computer network configured as a rhombic dodecahedron. Another embodiment of the invention is a two-dimensional network topology configuration, which is a projection of a six-dimensional polyhedral computer network, affording increased network performance.

### BRIEF DESCRIPTION OF THE DRAWINGS

Reference will be made to embodiments of the invention, examples of which may be illustrated in the accompanying figures, in which like parts may be referred to by like or similar numerals. These figures are intended to be illustrative, not limiting. Although the invention is generally described in the context of these embodiments, it should be understood that it is not intended to limit the spirit and scope of the invention to these particular embodiments. These drawings shall in no way limit any changes in form and detail that may be made to the invention by one skilled in the art without departing from the spirit and scope of the invention.

FIG. 1 shows an embodiment of a multiprocessor compute cluster designed in the shape of a polyhedron;

FIG. 2 shows an embodiment of a polyhedral multiprocessor cluster configured as a self-similar superstructure of polyhedra;

FIGS. 3, 4, 5, 6, 7, and 8 depict various views of an embodiment of a cuboctahedral multiprocessor cluster with centroid node;

FIGS. 9, 10, and 11 show two cuboctahedral multiprocessor clusters packed together;

FIG. 12 shows a close-packed lattice of cuboctahedral multiprocessor clusters;

FIG. 13 shows a diagram of a nearest neighbor traffic routing algorithm;

FIG. 14 shows a multiprocessor compute cluster designed in the shape of a rhombic dodecahedron with a centroid node;

FIG. 15 shows a close-packed lattice of rhombic dodecahedral multiprocessor clusters with centroid nodes according to embodiments in this patent document;

FIG. 16 depicts another embodiment of a polyhedral lattice topology in a datacenter according to embodiments in this patent document;

FIG. 17 depicts an embodiment of a server cabinet configured as a cuboctahedron with a radix switch acting as the centroid node;

FIG. 18 depicts a block diagram of the server cabinet shown in FIG. 17;

FIG. 19 depicts another embodiment of two server cabinets configured as a cuboctahedron with a radix switch acting as the centroid node;

FIG. 20 depicts a block diagram of the server cabinets shown in FIG. 19;

FIG. 21 depicts a block diagram of a cuboctahedral traffic routing pattern with centroid in according to embodiments in this patent document;

FIG. 22 depicts a network topology diagram of an interconnected, close-packed lattice network of six cuboctahedral-centroid topologies as depicted in FIGS. 23 and 24;

FIGS. 23 and 24 depict two views of a lattice of seven interconnected cuboctahedral compute clusters.

FIG. 25 depicts a network topology diagram of a rhombic dodecahedral plus centroid according to embodiments in this patent document;

FIG. 26 depicts a high-performance computer lattice comprised of layers of cuboctahedral microprocessor clusters;

FIG. 27 depicts nearest neighbor connections among 4 polyhedral compute clusters, showing dual and quad connections among neighboring peripheral nodes;

FIG. 28 depicts an isometric view of close-packed lattice of 27 cuboctahedral compute clusters, showing dual and quad connections among neighboring peripheral nodes;

FIG. 29 depicts a top, side, or bottom view of the lattice of FIG. 28;

FIG. 30 depicts a two-dimensional projection of a close-packed lattice of 27 cuboctahedral compute clusters, as a network topology diagram.

FIG. 31 depicts twenty-seven cuboctahedral server clusters configured in a rectilinear fashion, enabling a scalable polyhedral network topology within a rectilinear data center.

### DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. Furthermore, the use of memory, database, information base, data store, tables, hardware, and the like may be used herein to refer to system component or components into which information may be entered or otherwise recorded.

The terms “packet,” “datagram,” “segment,” or “frame” shall be understood to mean a group of bits that can be transported across a network. These terms shall not be interpreted as limiting embodiments of the present invention to particular layers (e.g., Layer 2 networks, Layer 3 networks, etc.); and, these terms along with similar terms such as “data,” “data traffic,” “information,” “cell,” etc. may be replaced by other terminologies referring to a group of bits, and may be used interchangeably.

Furthermore, it shall be noted that: (1) certain steps may optionally be performed; (2) steps may not be limited to the specific order set forth herein; (3) certain steps may be performed in different orders; and (4) certain steps may be done concurrently.

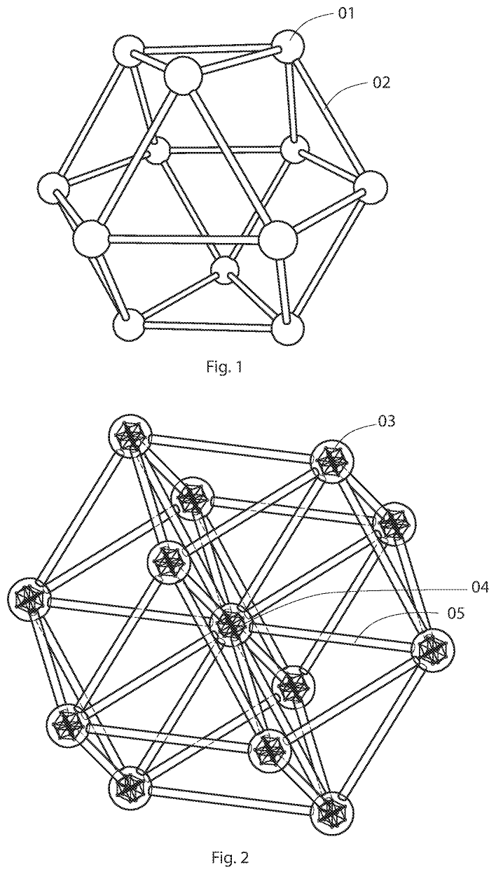

FIG. 1 shows one embodiment of the polyhedral microprocessor cluster. The cluster is formed by 1 microprocessors connected by 2 substantially similar connectors. These connectors are structural in nature, and act as infrastructure channels to supply power, cooling, and data among the microprocessors.

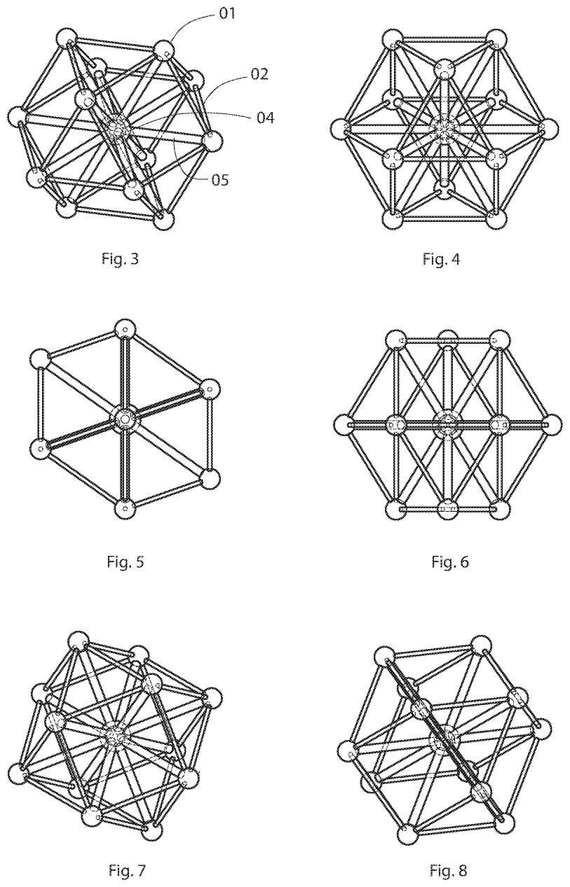

FIG. 2 shows another embodiment of a polyhedral multiprocessor cluster configured as a self-similar superstructure of polyhedra, in which the peripheral nodes 3 contain polyhedral microprocessor clusters. FIG. 2 also shows a centroid node 4 with additional connectors 5 connecting the centroid 4 node to the peripheral nodes 3. The cuboctahedron is a structure of interest for nearest-network computing and deep learning. Polyhedra in general are of interest for nearest-network computing due to their ability to stack in multiple dimensions, and connect along repeating vertices, which correspond to hops of data packets. The cuboctahedron is of particular interest for many reasons. It is the only polyhedron in which all edges are of equal length. It allows for an additional centroid node, which is also equidistant from all the peripheral vertices. Each individual node has a high number of connections to other nodes (12), higher than any other existing network typology. The cuboctahedron can be seen as a sphere with rectilinear boundaries, whereby combining the ideal computing matrix (a sphere) within the ideal manufacturing and maintenance environment (the rectilinear grid). Cuboctahedrons may be packed into a lattice according to the close-packing of equal spheres. The cuboctahedron is limitlessly and repeatedly configurable in all 6 directions, along a regular rectilinear grid, with implications for exascale computers. The sphere is the most thermodynamically efficient solid, with implications for managing heat exhaust. The cuboctahedron may be compressed into a tetrahedron and further flattened into a triangle, with implications for mobile supercomputers. A cuboctahedron with a centroid node and corresponding internal connectors is extremely structurally stable, with benefits for stacking large numbers of heavy units within a data center. The ratio of vertices or connectors to compute nodes increases parabolically as more clusters are added to the lattice, whereby increasing the supercomputer's bi-section bandwidth.

FIGS. 3, 4, 5, 6, 7, and 8 show the preferred embodiment of a polyhedral microprocessor cluster, which is a cuboctahedron with a centroid. In this embodiment, connectors 5 connect among the centroid 4 and the peripheral nodes 3. In this embodiment the centroid node is also differentiated from the peripheral nodes in that it contains additional memory, processors, and switches, corresponding to the number of peripheral nodes 3 it connects to. In the embodiment of a cuboctahedron, the centroid connects to 12 peripheral nodes 3, and in the embodiment of a rhombic dodecahedron it connects to 14 peripheral nodes 3.

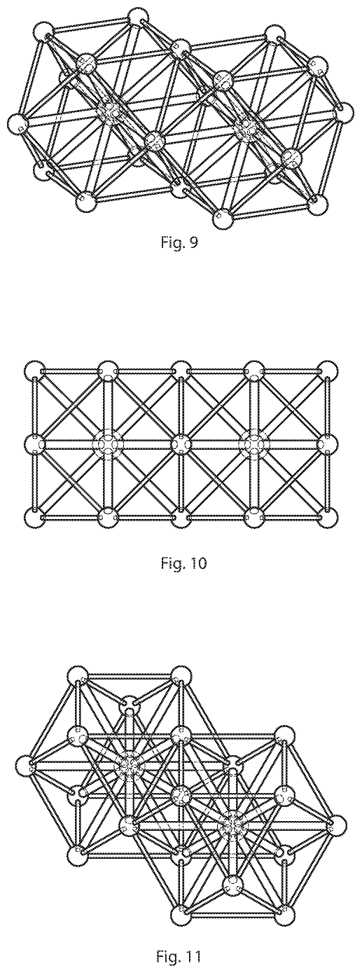

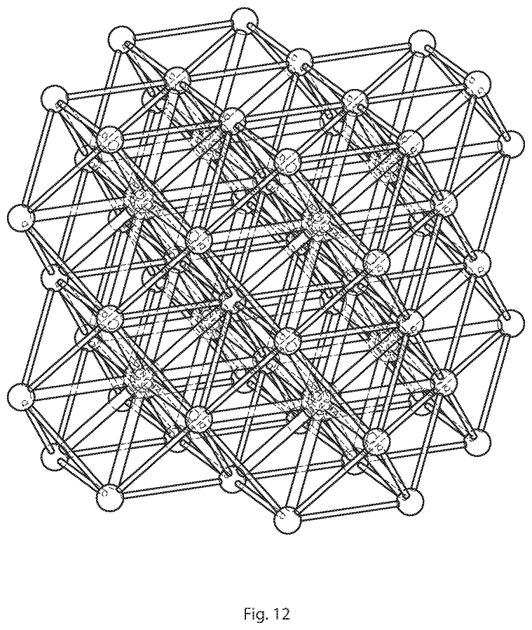

FIGS. 9, 10, and 11 show two connected cuboctahedral clusters along their square faces in the y-z plane. FIG. 12 shows a cuboctahedral lattice scaled in all three planes. Nodes which were previously external nodes gain additional connectivity when connected to adjacent clusters. This increases bisection bandwidth, creates an all-to-all network, increases number of direct hops.

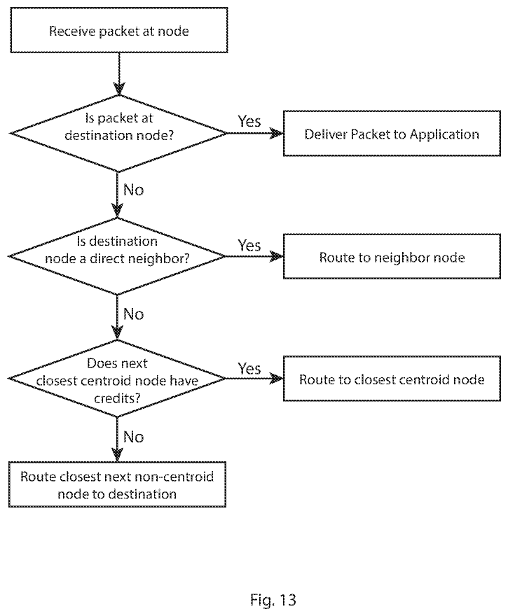

FIG. 13 is an algorithmic flow chart describing how data packets are routed in a cuboctahedral lattice shown in FIG. 12. Packets are preferably routed to the nearest centroid.

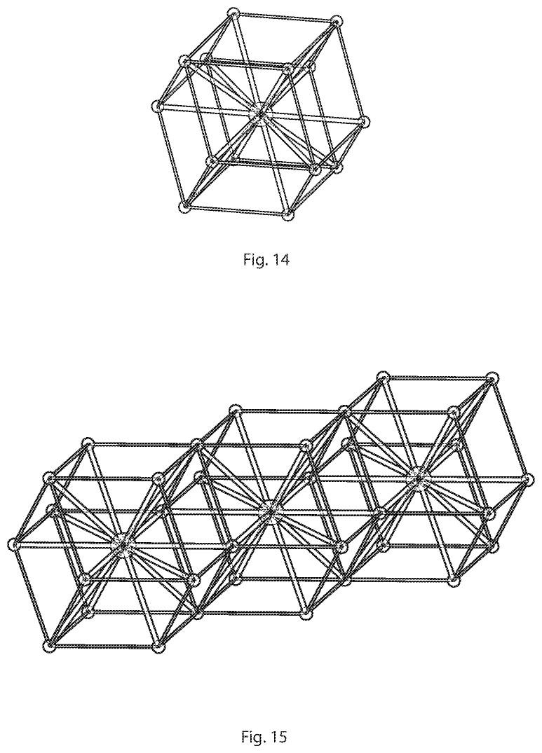

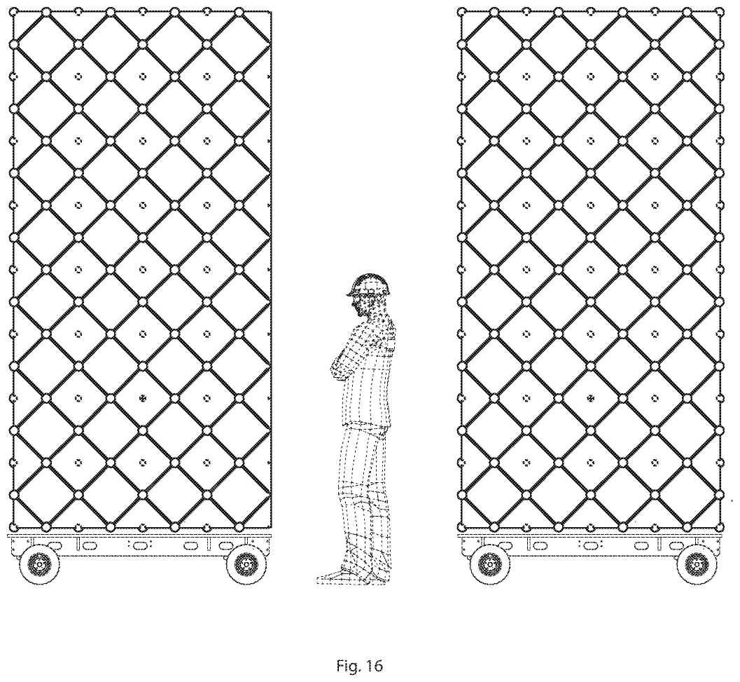

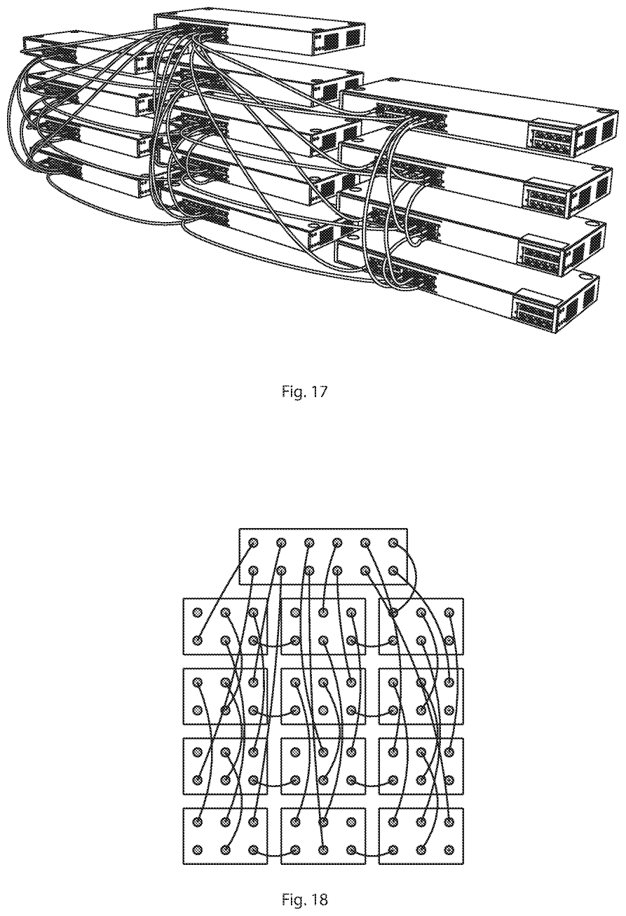

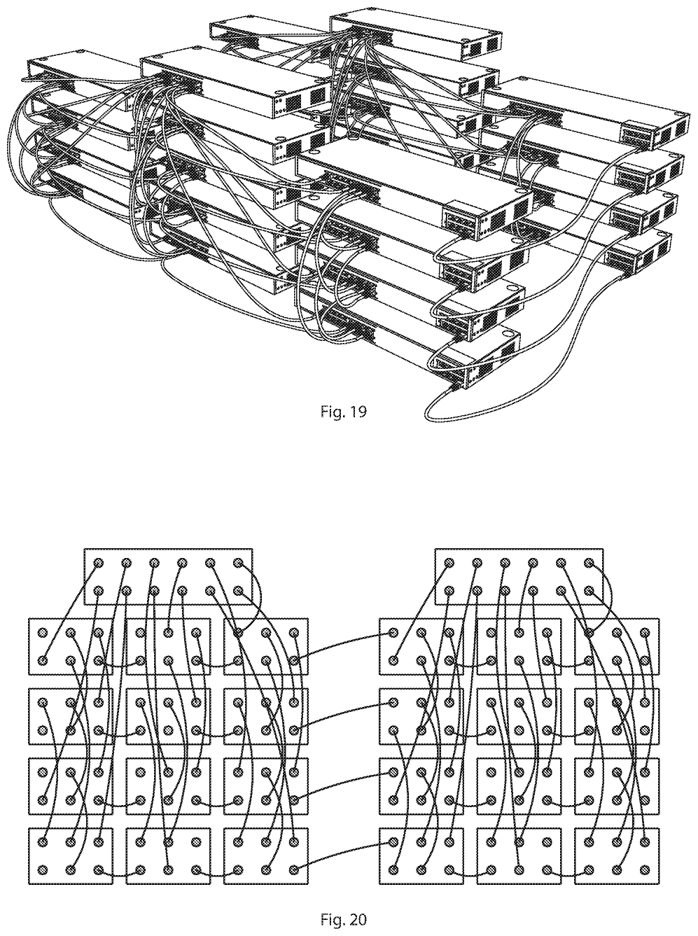

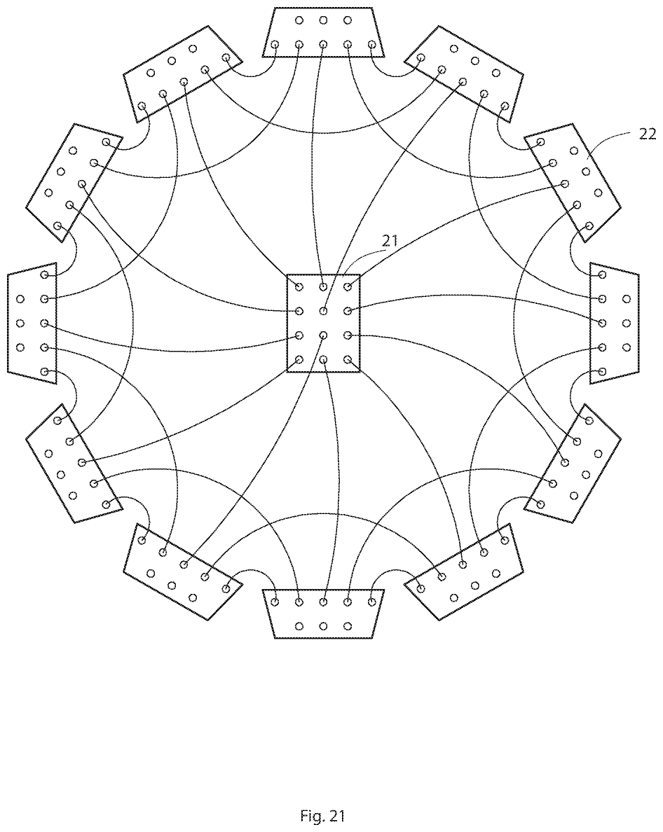

FIGS. 14 and 15 show a second embodiment of a polyhedral compute cluster and lattice. This polyhedron is a rhombic dodecahedron, which contains 24 external connectors and 14 external nodes. This embodiment also comprises 1 centroid node and 14 internal connectors connecting this centroid node to the external nodes. The rhombic dodecahedron offers more nearest neighbor connections, 14, yet requires two lengths of internal connectors.

FIG. 16 shows a data center comprised of polyhedral clusters stacked into rows, and in this illustration the rows are moveable by means of a chassis, so that a person may access any cluster. The inventors also contemplate access via robotic arms.

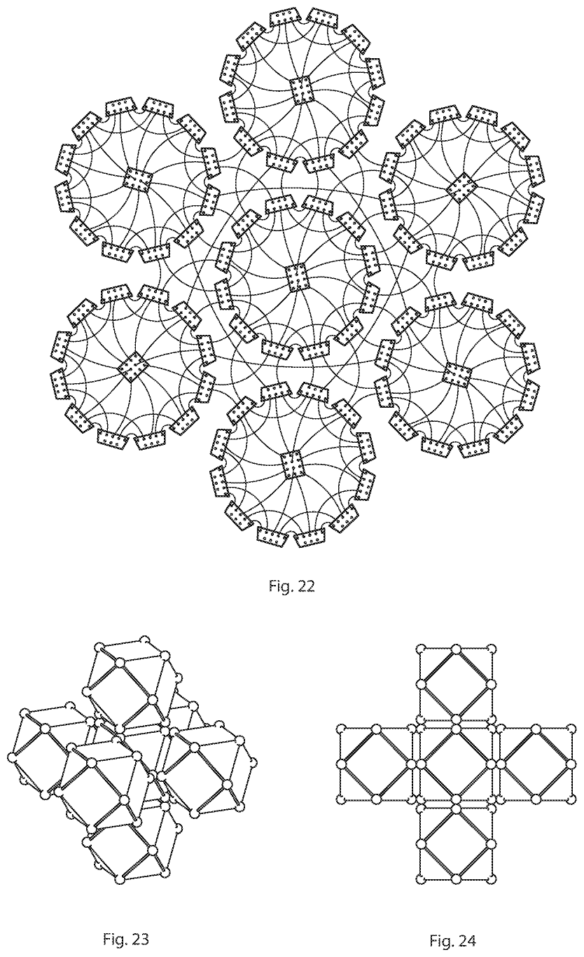

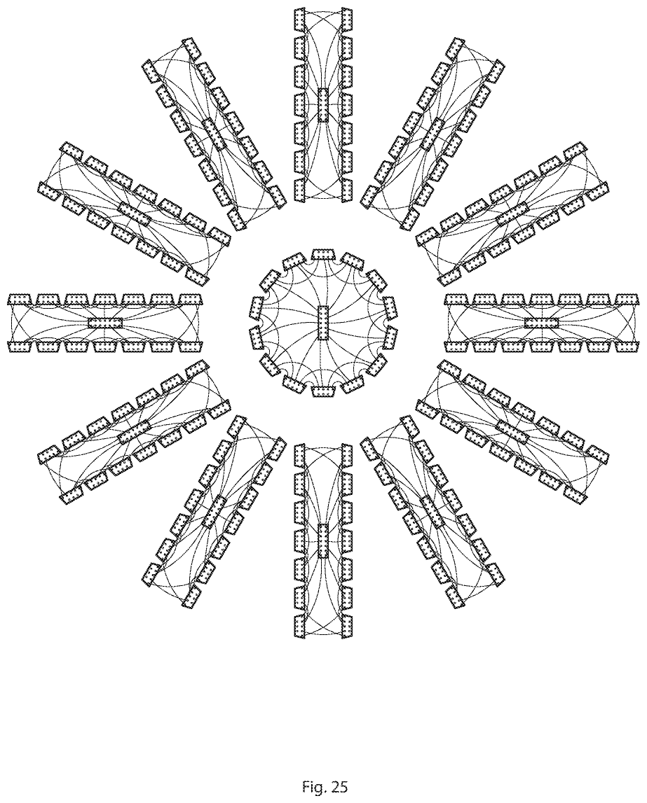

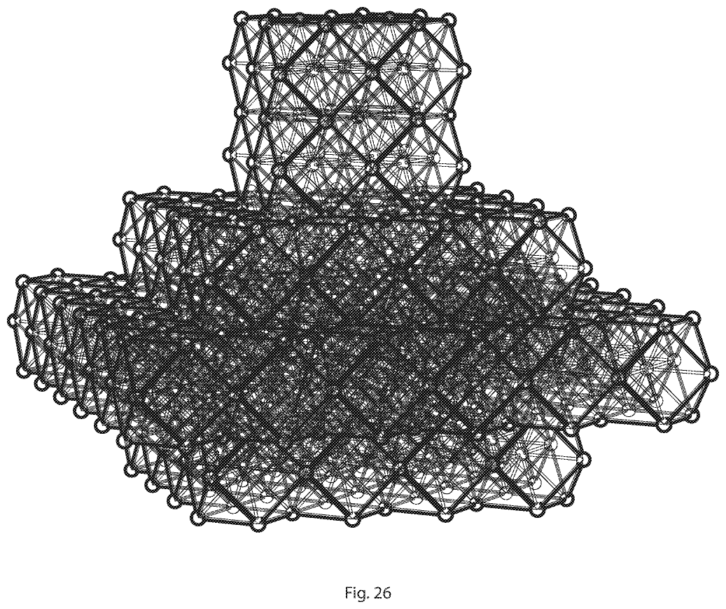

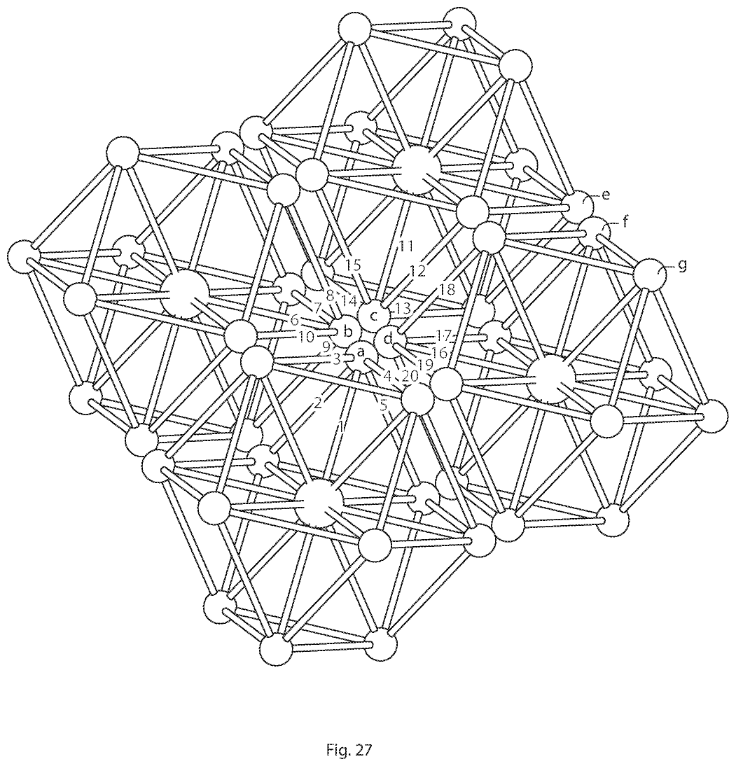

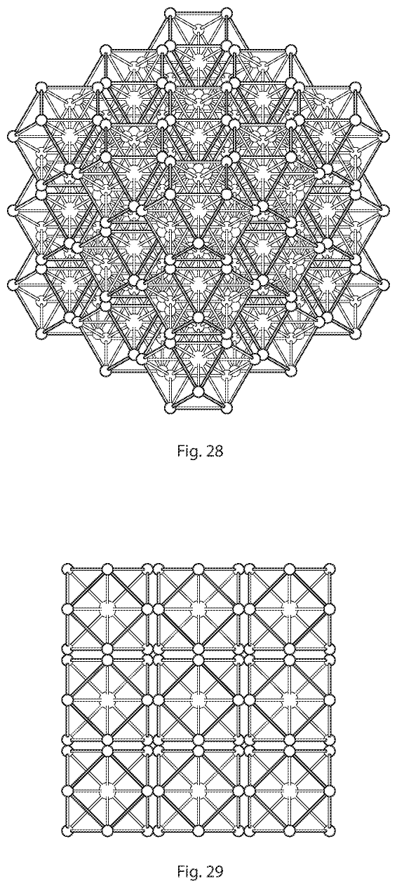

The above embodiments may be constructed using three-dimensional parts, or may be abstracted into 2-dimensional routing algorithms to connect conventional rectilinear servers. FIG. 21 shows a two-dimensional network diagram representing the same connectivity afforded by a multi-dimensional cuboctahedral microprocessor cluster with centroid node, where 21 represents a 12-port switch as a centroid node, and 22 represents an 9-port switch as a peripheral node. FIG. 22 shows a two-dimensional network diagram representing a lattice of a cuboctahedral cluster packed with six neighboring clusters on all six of its square faces. This packing on 6 square faces is analogous to Torus 6-D packing but because the cuboctahedron is a multifaceted shape, the end result is double the connections and double the bisection bandwidth.

FIG. 29 shows a network diagram representing a two-dimensional projection of a lattice of rhombic dodecahedral compute clusters with centroid nodes.

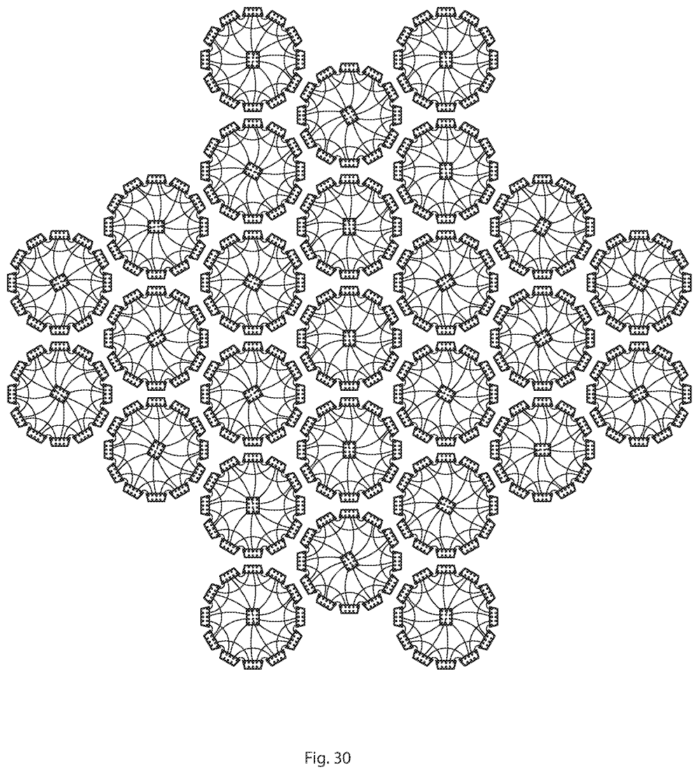

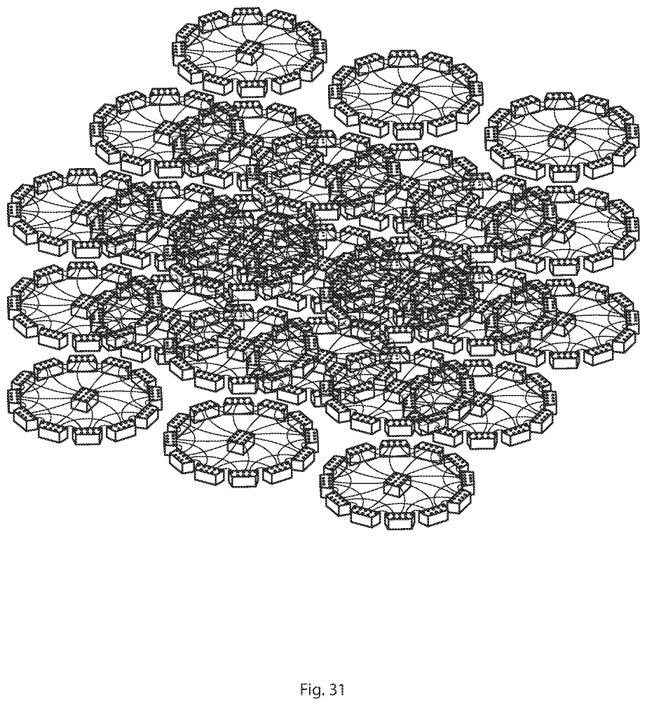

FIG. 30 shows a specific embodiment of a data center, comprised of multiple layers of interconnected cuboctahedral clusters. In this embodiment, the lowest layer comprises fewer clusters, the next layer is wider, following by tapered layers. This pattern is analogous to two-dimensional diagrams of machine learning algorithmic patterns and is therefore beneficial for processing those workloads.

FIG. 29 shows a small cluster of cuboctahedral compute clusters, illustrating many advantages of close-packing. Peripheral compute nodes a, b, c, and d connect to become a quad core computer, with 20 chips inside. Before packing, compute node a had 5 connections: 1 to its centroid and 2, 3, 4, 5 to its peripheral neighbors. After packing, it gains 15 more connections via its 3 nearest neighbors b, c, and d: 6, 7, 8, 9, 10, 11, 12, 13, 14, 15, 16, 17, 18, 19, and 20. Peripheral nodes e and f, which are found on the envelope of this super-structure, form a dual-quad computer with 10 chips inside. If for example each chip contains 64 processors, then each independent cuboctahedral cluster would contain 64×13 or 832 processing cores. When packed, each quad core computer would contain 64×20 or 1280 processing cores, and each dual core would contain 64×10 or 640 processing cores. The configurations described herein offer substantially improved processing power and networking over the same quantity of existing processors configured in a conventional rectilinear grid or layers of grids. The envelope also exhibits peripheral nodes with no added connections from the cluster g. These nodes g may serve as access or supply to the rest of the network. In this embodiment, clusters are connected without eliminating adjacent nodes, which allows higher network scalability, whereas in the lattice embodiment of described in FIGS. 9, 10, 11, and 12, adjacent nodes merge into one nodes.

The inventors observe that much of the natural world, specifically electricity and organic neural action potentials, exhibit patterns more complex and subtle than rectilinear grids, such as fractals and dendrites. The inventors contemplate that the ideal compute scaffolding would mimic those patterns. Therefore, the inventors surmise that network patterns, such as those disclosed in FIGS. 22 23, and 25, more accurately and naturally process electronic information than any of the rectilinear high-performance compute structures disclosed today. In particular this applies to neural network processing.

Several high-performance networking topologies exist today, including Dragonfly, Dragonfly plus, Fat Tree, 2-Level Fat Tree, 3-Level Fat Tree, Cascade, 3D HyperX, Stacked All-to-all, Stacked 2D HyperX, 2 Level OFT, and Slim Fly. Each of these has inherent limitations regarding cost vs efficiency, cooling, and scalability. What is needed is a network design which is virtually infinitely scalable, coolable, repairable, transportable, and cost-efficient, with a higher number of intrinsic nearest neighbor connections and shared memory, and a way to scale the network for more connections.

Slimfly computer design guarantees that no node is more than 4 hops away from other nodes in the network. However, what is needed is a network in which no node is located more than 1 or 2 hops away from other nodes in the network.

Fat Tree design places the computing power of the network out of the rack and above the other servers. What is needed is a configuration wherein the compute power is directly in the middle of that network piece to improve memory, connectivity, and to reduce cabling lengths and thereby costs and latency.

Torus networks are inherently limited in their computing power because the maximum number of neighbor ports will never extend beyond 6. Torus networks are not scalable. This limits the depth of machine learning calculations. Additionally, the torus wrap-around link's length is as long as the entire network's side length, of N*the number of internal links, whereby creating latency. Additionally, this longer length, in relation to the internal connections, creates an irregular kit of parts, which makes repair difficult and scaling costly. Torus networks are also nearly impossible to repair because the compute node cannot be split apart. What is needed is a network which offers more neighboring ports, with equidistant links, at a lower cost. The cuboctahedron and rhombic dodecahedron offer the same scalability in all three regular planes as the Torus 6-D network, but with substantially more nearest neighbor connections, 12 and 14, respectively.

Dragonfly and Dragonfly Plus are advantageous because of local all-to-all connections that are local, so no node in a two-cabinet group is located more than two hops away. What is needed is a way to scale this 2-hop connectivity outside of two cabinets.

Much of the prior art does not have scalable bisection bandwidth since their network switches are discreet units which usually comprise 36 or 48 ports. These numbers of ports are somewhat arbitrary, meaning, they are not associated with any best practices for high performance compute nodes.

Conventional switching hubs lack user-friendly indicators associating logical ports with physical ports. What is needed are such indicators to allow ease of construction and maintenance of data centers.

Network switches are traditionally configured in data centers in longitudinal rows, wherein heat produced by the servers is expelled as hot air longitudinally into the aisle behind the servers. This is also inefficient because heat travels up. What is needed is a more thermodynamically efficient structure for cooling supercomputers. Today's data centers require significant investments of space and maintenance costs for cooling.

Traditional data centers are traditionally stationary. What is needed is a solution for mobile supercomputing with sufficient cooling apparatus or improved heat dissipation.

With the cuboctahedron and rhombic dodecahedron, we address many longstanding issues with the manufacturing, maintenance, and cooling of supercomputers and data centers. We are also able to demonstrate an improvement in high performance computing, specifically, nearest network computing for deep learning. Repeating, non-orthogonal connections among compute nodes offers a variety of significant improvements for supercomputers.

Many advanced computing algorithms, particularly those for machine learning and neural networks, benefit from numerous, non-orthogonal connections with neighbors. In fact, these algorithms attempt to recreate processes found in neural tissues, and the natural world. These connection patterns might be described as dendritic, fractal, Fibonacci, or other mathematical patterns seen in nature. Current man-made physical computing networks ad microprocessors are all designed as rectilinear systems.

What is needed therefore is a computing infrastructure which in infinitely scalable, naturally dissipates heat, and supports advanced functions such as nearest neighbor computing. The present embodiments offer improved connectivity over fixed radix switches by enabling modular components to be connected, creating a virtually limitless network, wherein the scalability is only limited by infrastructure such as the size of the data center, the connector's strength, and the weight of the system.

### PRIOR ART

Patent References

| Patent Number | Title | Inventor(s) | Filing Date |
|---|---|---|---|
| US 20090164435 A1 | Methods and systems for quantum | Thomas J. Routt | Dec. 20, 2007 |
| | search, computation and memory | | |
| US2017/0172008 | SYSTEMS AND METHODS FOR | Narayanan; Rajesh | Jun. 15, 2017 |
| | TWO LAYER THREE DIMENSIONAL | | |
| | TORUS SWITCHED CONNECTIVITY | | |
| | DATACENTER TOPOLOGY | | |
| US20160028613A1 | Dragonfly Plus: Communication | Zachy Haramaty et | 2014 Jul. 22 |
| | Over Bipartite Node Groups | al | |
| | Connected by a Mesh Network | | |
| US 20100049942 A1 | Dragonfly processor | John Kim et al | 20 Aug. 2008 |
| | interconnect network | | |
| US20100049942A1 | Dragonfly processor | John Kim | *2008 Aug. 20 |
| | interconnect network | | 2010 Feb. 25 |
| US20120144064A1 | Progressive adaptive routing | Mike Parker, Steve | *2010 Nov. 5 |
| | in a dragonfly processor | Scott, Albert | 2012 Jun. 7 |
| | interconnect network | Cheng, John Kim | |
| US20030002443A1 | System and method for enhancing | Claude Basso et al | 2003 Jan. 2 |
| | the availability of routing systems | | |
| | through equal cost multipath | | |
| US20120320926A1 | Distributed Link Aggregation Group | Dayavanti G. | 2012 Dec. 20 |
| | (LAG) for a Layer 2 Fabic | Kamath, et al | |
| US20110258641A1 | Remote Adapter Configuration | William J. | 2011 Oct. 20 |
| | | Armstrong | |
| US20060235995A1 | Method and system for imple- | Jagjeet Bhatia | 2006 Oct. 19 |
| | menting a high availability VLAN | | |
| US20100257263A1 | Method and apparatus for | Martin Casado | 2010 Oct. 7 |
| | implementing and managing | | |
| | virtual switches | | |
| US20130070762A1 | System and methods for | Robert Edward | 2013 Mar. 21 |
| | controlling network traffic | Adams | |
| | through virtual switches | | |
| U.S. Pat. No. 8,391,289B1 | Managing a forwarding | Praveen | 2013 Mar. 5 |
| | table in a switch | Yalagandula | |
| US20030152087A1 | Excess-port switch | Troy Shahoumian | 2003 Aug. 14 |
| U.S. Pat. No. 8,139,492B1 | Local forwarding bias in | Eric L. Peterson | 2012 Mar. 20 |
| | a multi-chassis router | | |
| US20130003735A1 | Dynamically provisioning | H. Jonathan Chao | 2013 Jan. 3 |
| | middleboxes | | |
| U.S. Pat. No. 9,042,234B1 | Systems and methods for efficient | Christopher D. | 2015 May 26 |
| | network traffic forwarding | Liljenstolpe | |
| US20100061391A1 | Methods and apparatus related | Pradeep Sindhu | 2010 Mar. 11 |
| | to a low cost data center | | |
| | architecture | | |
| US20100061242A1 | Methods and apparatus related | Pradeep Sindhu | 2010 Mar. 11 |
| | to a flexible data center | | |
| | security architecture | | |
| U.S. Pat. No. 8,239,572B1 | Custom routing decisions | Eric Jason | 2012 Aug. 7 |
| | | Brandwine | |
| US20070297406A1 | Managing multicast groups | Mo Rooholamini | 2007 Dec. 27 |
| US20090141622A1 | Pinning and protection on link | Nabil N. Bitar | 2009 Jun. 4 |
| | aggregation groups | | |
| U.S. Pat. No. 8,296,459B1 | Custom routing decisions | Eric Jason | 2012 Oct. 23 |
| | | Brandwine | |
| US20110096668A1 | High-performance adaptive routing | Gil Bloch | 2011 Apr. 28 |
| US20110273988A1 | Distributing decision making in a | Jean Tourrilhes | 2011 Nov. 10 |
| | centralized flow routing system | | |
| US20110261831A1 | Dynamic Priority Queue Level | Puneet Sharma | 2011 Oct. 27 |
| | Assignment for a Network Flow | | |
| US20100061389A1 | Methods and apparatus related | Pradeep Sindhu | 2010 Mar. 11 |
| | to virtualization of data | | |
| | center resources | | |
| US20050195845A1 | Low cost implementation for | David Mayhew, | 2005 Sep. 8 |
| | a device utilizing look ahead | Karl Meier, Nathan | |
| | congestion management | Dohm | |
| US20130235870A1 | Methods, Systems, and Fabrics | Sunay Tripathi | 2013 Sep. 12 |
| | Implementing a Distributed Network | Robert James Drost | |
| | Operating System | Chih-Kong Ken Yang | |
| US20130003549A1 | Resilient Hashing for Load | Brad Matthews | 2013 Jan. 3 |
| | Balancing of Traffic Flows | | |
| CN 103957163 A | Network topology structure | [symbol] , [symbol] , [symbol] | Mar. 7, 2014 |
| | based on fat tree high | [symbol] , [symbol] | |
| | scalability hypercube | | |
| US 20120144065 A1 | Table-driven routing in | Mike Parker, Steve | Nov. 5, 2010 |
| | a dragonfly processor | Scott, Albert | |
| | interconnect network | Cheng, Robert | |
| | | Alverson | |

### NON-PATENT REFERENCES

Alistarh, et al. “A High-Radix, Low-Latency Optical Switch for Data Centers”. SIGCOMM '15 August 17-21, 2015, London, United Kingdom c 2015 Copyright held by the owner/author(s). ACM ISBN 978-1-4503-3542-3/15/08.
Besta, Maciej etc., Slim Fly: a cost effective low-diameter network topology “(a cost-effective, low diameter of the network topology Slim Fly), International Conference for High Performance computing, networking, Storage and Analysis2014 (SC2014)
Chen, Dong, et al. “An Evaluation of Network Architectures for Next Generation Supercomputers”. 2016 7th International Workshop on Performance Modeling, Benchmarking and Simulation of High Performance Computer Systems, IBM Thomas J. Watson Research Center, Yorktown Heights, New York.
Edwards, Arthur H. “Reconfigurable Memristive Device Technologies”. Published in: Proceedings of the IEEE (Volume: 103, Issue: 7, July 2015).
Fuller, R. Buckminster. “The Vector Equilibrium: Everything I Know Sessions.” Philadelphia, Pa.: 1975. https://conversationswithbucky.pbworks.com/w/page/16447472/Tape %203b
Fuller, Buckminster et al. “Synergetics: Explorations in the Geometry of Thinking.” Macmillan [3], Vol. 1 in 1975, and Vol. 2 in 1979 (ISBN 0025418807).
Jouppi, Norman P. et al. “In-Datacenter Performance Analysis of a Tensor Processing Unit”. Google, Inc., Mountain View, Calif. USA. 44th International Symposium on Computer Architecture (ISCA), Toronto, Canada, Jun. 26, 2017.
Morgan, Timothy Prickett. “Cray CTO Connects The Dots On Future Interconnects”, Jan. 8, 2016, https://www.nextplatform.com/2016/01/08/cray-cto-connects-the-dots-on-furure-interconnects.
McGovern, Jim. “An Exploration of a Discrete Rhombohedral Lattice of Possible Engineering or Physical Relevance”. Presented at The International Mathematica Symposium, Maastricht, The Netherlands, June 20-24th 2008.
MOGUL J C ET AL: “DevoFlow: Cost-Effective Flow Management for High Performance Enterprise Networks”, 20 Oct. 2010 (2010-10-20), pages 1-6, XP002692074, ISBN: 978-1-4503-0409-2, http://www.hpl.hp.com/personal/Puneet_Sharma/docs/papers/hotnets2010.pdf.
Nugent, Michael Alexander et al. “AHaH Computing—From Metastable Switches to Attractors to Machine Learning”. Published: Feb. 10, 2014. https://doi.org/10.1371/journal.pone.0085175
Santoro, Nicola. “DESIGN AND ANALYSIS OF DISTRIBUTED ALGORITHMS”. Carleton University, Ottawa, Canada Copyright © 2007 by John Wiley & Sons, Inc.
Weisstein, Eric W. “Sphere Packing.” From MathWorld—A Wolfram Web Resource. http://mathworld.wolfram.com/SpherePacking.html
Y. Ajima et al., “Tofu: A 6D Mesh/Torus Interconnect for Exascale Computers”, IEEE Computer, IEEE Computer Society, US, vol. 42, No. 11, Nov. 2009, pp. 36-48.

The invention claimed is:

1. A multiprocessor compute cluster designed in the shape of a polyhedron, comprising:
a. compute nodes, containing computer processors and associated components for their operation, which correspond to the peripheral vertices of said polyhedron,
b. computer infrastructure channels, which correspond to the peripheral edges of said polyhedron, which contain cooling, power, and communication cables,
wherein the channels connect the compute nodes to each other, corresponding to vertices of a polyhedron,
whereby said compute nodes' dispersed locations on the polyhedron's convex surface improves heat dissipation,
whereby compute nodes computational, network, power and cooling capabilities grow as polyhedron cubes are added.

2. A dominant node located at the centroid of the polyhedral cluster according to claim 1, which comprises:
a. a networking switch or configuration of ports attached to said centroid compute node, wherein the quantity of ports corresponds to the quantity of peripheral compute nodes at the polyhedron's vertices,
b. additional infrastructure channels connecting the centroid node to each of the peripheral compute nodes,
c. multiple processors, whose quantity corresponds to the quantity of connections to peripheral nodes,
d. memory, such as but not limited to RAM, DRAM, or SSD,
e. connectors which connects channels to the nodes,
whereby said centroid node increasing the connectivity of the cluster, by increasing the number of neighboring connections, and reducing the number of hops in a corresponding routing algorithm, which aims to route traffic through the centroid node,
whereby substantially increasing the structural stability of the cluster, and enabling improved stacking in a data center environment,
whereby said centroid node differentiates from the peripheral nodes and transforms into a super-network node due to increased connectivity.

3. The polyhedral multiprocessor cluster of claim 1 configured as a cuboctahedron, comprised of:
a. equidistant infrastructure channels located along the cuboctahedron's peripheral vertices,
b. an additional compute node located at the centroid of the cuboctahedron,
c. additional equidistant infrastructure channels connecting the centroid node to the peripheral nodes located at each of the vertices;
wherein each compute node is connected to its nearest neighbors by equidistant infrastructure channels, whereby affording better communication performance among the nodes and reducing latency,
wherein the equidistant channels and similar compute nodes form a modular system of parts, whereby substantially increasing the system's ease of installation and portability, and reducing cost of installation and maintenance.

4. The polyhedral multiprocessor cluster of claim 1 configured as a rhombic dodecahedron, comprised of:
a. equidistant infrastructure channels located along the rhombic dodecahedron's peripheral edges,
b. compute nodes located at each of the rhombic dodecahedron's peripheral vertices,
c. an additional compute node located at the centroid of the rhombic dodecahedron,
d. infrastructure channels connecting the centroid node to the exterior nodes located at each of the vertices;
wherein each peripheral compute node is connected to its nearest neighbors by equidistant infrastructure channels, and the centroid node is connected to peripheral nodes by channels of two distinct lengths,
whereby the rhombic dodecahedron's geometry affords a greater quantity of connections among the centroid and peripheral nodes than a cuboctahedron, affording better scaffolding for workloads such as convolutional neural networks,
wherein the faces of a rhombic dodecahedron are all substantially similar parallelograms,
whereby affording a modular assembly kit, workload organization and other advantages.

5. The polyhedral multiprocessor cluster of claim 1 configured as a self-similar superstructure of polyhedra, wherein each compute node of claim 1 is analogous to a smaller, complete polyhedral multiprocessor cluster, comprising
a. an additional set of microprocessors whose quantity corresponds to the vertices and centroid of a regular polyhedral solid,
b. smaller infrastructure channels connecting said microprocessors,
c. superstructure channels connecting among said smaller polyhedra,
d. each node contains 12 microprocessors, which share memory,
whereby the configuration of said components enables better heat dissipation, scalable shared memory, and higher performance than if the same quantity and type of components were configured in a rectilinear grid.

6. The infrastructure channels of the polyhedral multiprocessor cluster of claim 1 constructed from substantially straight, rigid tubes, whereby said channels also act as hops in a nearest neighbor network.

7. The compute nodes of claim 1 which comprise batteries,
wherein said batteries are continuously charged from electrical supply or heat within the compute node,
whereby enabling a smart shut-down process,
whereby improving the thermodynamics of the node by equally distributing and dispersing heat exhaust in the space among the equidistant clusters,
whereby protecting the network from power outages and reducing costs for external battery backups.

8. The compute nodes of claim 1 which also comprise light indicators, whereby providing visual cues, whereby improving ease of manually locating a specific node with a lattice, in addition to a connected software indication at a remote-control station.

9. A high-performance computer network comprised of:
a. substantially similar polyhedral multiprocessor clusters of claim 1
b. a second type of mechanical connector on the peripheral nodes,
c. external interface connectors, affixed to certain nodes on certain clusters, when said nodes become positioned on the peripheral envelope of a lattice,
wherein said clusters are tessellated into a close-packed lattice, repeating along the planes of the polyhedron, by means of mechanical, electrical, computational, and communication network connections among distinct clusters, whereby the creating a scalable network, which affords a substantially improved high performance computer, regarding structural stability, modularity, maintenance, energy efficiency, and workloads such as nearest neighbor computations,
wherein each added connection adds effectively the same quantity of memory and compute power to each node, whereby scaling and growing the performance of the network in addition to its size,
while the centroid node's immediate structure and connections do not change when configured in a lattice, it grows virtually by virtue of connecting its peripheral nodes to another clusters', said centroid's memory effectively extends across the lattice in all the polyhedral planes' directions, creating an enhanced distributed memory machine, or, a massively parallel shared memory system, whereby extracting more use from conventional processors, wherein certain areas of the lattice may be programmed to be shared memory, and other areas local memory, creating a scalable high-performance system,
wherein nodes of distinct clusters are connected via ports or slots, whereby enabling differentiated levels of activity: motherboard-to-motherboard activity between the connected nodes, intermediate local connectivity between these connected nodes and the nodes of the neighboring cluster separated by one channel, which functions as a compute hop, and a third level of connectivity over the next nearest channel or two hops,
wherein some of the clusters' peripheral nodes gain new connections with adjacent neighboring nodes, whereby creating classes of connectivity depending on where the node is located in the lattice and how many polyhedral vertices are packed up to it, expressed as ports on motherboards being connected or fallow, namely, some peripheral nodes become dual compute nodes by means of one connection with one neighboring node, and some peripheral nodes become quad compute nodes by means of one connection with one neighboring node,
wherein some of the clusters' peripheral nodes, by virtue of their new location on the peripheral envelope of the assembled lattice, do not gain any more connections, and may transform into infrastructure nodes, by means of said nodes' unused slots or external interface connectors, are used for external linkages to resources such as power, cooling, and data communication, whereby substantially increasing bandwidth,
wherein whole clusters, according to their location within the lattice configuration, may differentiate to take on tasks such as specific processing tasks within a workload, or infrastructure tasks such as powering, or cooling, whereby increasing the efficiency of said tasks.

10. The task differentiation of claim 9 wherein the compute nodes at the initial location in the workload flow, such as at the lower rungs of the cluster, manage more robust computing tasks, while the upper or end nodes are responsible for powering the entire lattice.

11. The lattice of claim 9 wherein said polyhedral clusters are close-packed, as a face-centered cubic (fcc) regular lattice, oriented in the square plane, wherein the peripheral compute nodes of one rectangular face of a polyhedral cluster connect to mirroring compute nodes of its neighboring polyhedron's face, wherein the square plane may be the x-y, x-z, or z-y plane, wherein the packing may repeat itself along a plurality of square planes, whereby creating a scalable computer.

12. The lattice of claim 9 wherein said polyhedral clusters are close-packed, as a face-centered cubic (fcc) regular lattice, oriented in the triangular plane.

13. The lattice of claim 9 wherein said polyhedral clusters are close-packed, as a hexagonal close-packed (hcc) regular lattice.

14. A high performance computer network of claim 9, wherein the lattice's peripheral compute nodes are further comprised of reusable locking mechanisms, wherein the locking mechanisms enable the lattice to attach and detach from neighboring compute nodes, whereby the lattice may be disassembled, dismantled, or compressed, into a less voluminous bundle,
whereby enabling modular installation of a data center,
whereby enabling assembly and disassembly of a data center in various locations,
Whereby enabling ease of transport and repair,
whereby enabling on-site connectivity of polyhedral compute lattices from multiple distinct locations, whereby improving computational power and interdepartmental communication, by combining distinct workloads into one network.

15. The infrastructure channels of claim 1 which are further comprised of tension fittings at each end, whereby enabling the connectors to detach, without disrupting critical infrastructure supply lines which remain connected to the nodes, whereby affording the network to collapse into a substantially smaller, flatter mass for transport or storage.

16. The lattice of claim 9 wherein its peripheral envelope's contours enable and correspond to specific computing workloads, and whose peripheral envelope's contours widen then taper, whereby enabling parallel workloads such as convolutional neural networks.

17. An adaptive routing algorithm which describes a polyhedral high-performance compute network, which aims to route packets through centroid nodes via the least number of hops among node-channel-centroid connections.

18. A computer network topology configured as a 2-dimensional projection of a 6-dimensional polyhedral computer cluster, comprised of:
a. a plurality of conventional servers, configured in a rectilinear frame, which correspond to a polyhedron's peripheral compute nodes,
b. a radix switch, which corresponds to a polyhedron's centroid node,
c. a rectilinear scaffolding,
wherein the radix switch is connected to each of the servers by the shortest distance possible,
wherein each server is connected to a plurality of neighboring servers in the frame by the shortest distance possible, corresponding to connections among peripheral vertices on the surface of a regular polyhedron,
wherein said 2-dimensional network may connect to other analogous networks, by means of connecting a plurality of servers in one frame to corresponding servers in another frame, analogous to close-packing of polyhedra in a 3-dimensional lattice,
whereby creating a more efficient fat tree topology, while eliminating the need for torus wrap-around connections,
whereby increasing connectivity and computing power using conventional infrastructure.

19. The 2-dimensional polyhedral high-performance computer network of claim 19, configured as a projection of a cuboctahedron, comprised of:
a. 12 servers acting as peripheral compute nodes,
b. one radix switch acting as a centroid node,
c. a rectilinear scaffolding,
wherein the cuboctahedral topology supports equidistant connections among the servers and radix switch, whereby affording improved performance through lower latency and better routing traffic.

20. The 2-dimensional polyhedral high-performance computer network of claim 19, configured as a projection of a rhombic dodecahedron, comprised of:
a. 14 servers acting as peripheral compute nodes,
b. one radix switch acting as a central node,
c. a rectilinear scaffolding,
whereby the increased number of peripheral compute nodes increases efficiency of complex workloads such as convolutional neural networks.
